(19) United States
(12) Patent Application Publication
(10) Pub. No.: US 2007/0012126 A1
(43) Pub. Date: Jan. 18, 2007

(54) Electro-mechanical screw actuator assembly

(75) Inventors: Richard Corbett, Tours (FR); Ettore Berutti, Torino (IT)

Correspondence Address: MERCHANT & GOULD PC, P.O. BOX 2903, MINNEAPOLIS, MN, 55402-0903, US

(73) Assignee: AKTIEBOLAGET SKF, Goteborg (SE)

(21) Appl. No.: 10/539,189

(22) PCT Filed: Dec. 22, 2003
(86) PCT No.: PCT/EP03/14703

§ 371 Date: Jun. 22, 2006

(30) Foreign Application Priority Data
Dec. 20, 2002 (IT) TO2002-001103

(51) Int. Cl. F16H 1/20

(52) U.S. Cl. 74/89.26

(57) ABSTRACT

An electro-mechanical screw actuator assembly comprises a housing (11) fixable to a motor vehicle, an electric motor (30) mounted within the housing (11) and including a stator (31) fixed to the housing (11) and a rotor (34), a screw mechanism (60) including a rotatable nut (61) and a central screw (62) translatable along a given axis (x), a gear reduction system (50) disposed between the rotor (34) and the screw mechanism (60) for provoking translation of the screw (62). The housing (11) is secured to or integral with a supporting member (21) of tubular cylindrical shape extending within the housing (11) coaxially to the axis (x). The supporting element (21) externally supports rotatably the rotor (34) of the electric motor (30), and internally supports rotatably the nut (61) of the screw mechanism (60).

The present invention refers to an electro-mechanical screw actuator assembly of the type mentioned in the preamble of claim 1.

Actuator assemblies of the above type are known, for example, from U.S. Pat. No. 6,315,092. These actuators are applied in various fields, for example in the automotive field for actuating brakes, friction clutches, gearboxes, etc. An electric motor, mounted within a housing fixable to the vehicle, drives for rotation a nut member of a screw mechanism through a gear reduction system. The screw mechanism comprises a screw connected to a piston actuating head which is imparted a reversible linear motion with a high actuating force.

A problem encountered with conventional electro-mechanical actuator assemblies is due to the play between the various transmission members of the assembly, that are generally cascade connected. The tolerance of the couplings between the transmission members add up, allowing misalignment between the rotation or translation axes of these members, that are so subjected to early and non-uniform wear. Particularly, with use, the gears of the planetary reduction system have a tendency to wear very quickly if they are not kept correctly aligned parallel to the central longitudinal axes of the actuator, that coincides with the axis of translation of the piston member. An excessive increase of the play and the consequent misalignment of the axes of the transmission members leads to a loss of efficiency of the actuator assembly and shortens its life.

The object of the present invention is therefore to provide an electro-mechanical screw actuator assembly, adaptable to a wide range of applications, capable of obviating the above discussed inconvenience of prior art and particularly guaranteeing parallelism of the rotation or translation axes of the rotating and translating members of the assembly.

The foregoing, as well as other objects and advantages, that will be better understood herein after, are achieved according to the invention by an electro-mechanical actuator assembly having the features defined in the appended claims.

The constructional and functional features of a few preferred but not limiting embodiments of the invention will know be described with reference to the accompanying drawings, in which:

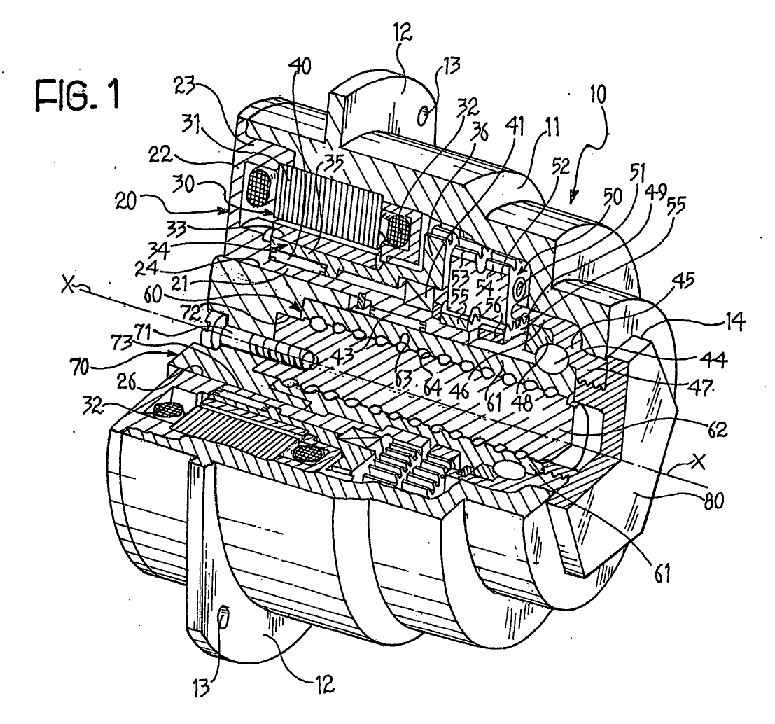

FIG. 1 is a partially sectioned prospective view of an actuator assembly according to the invention;

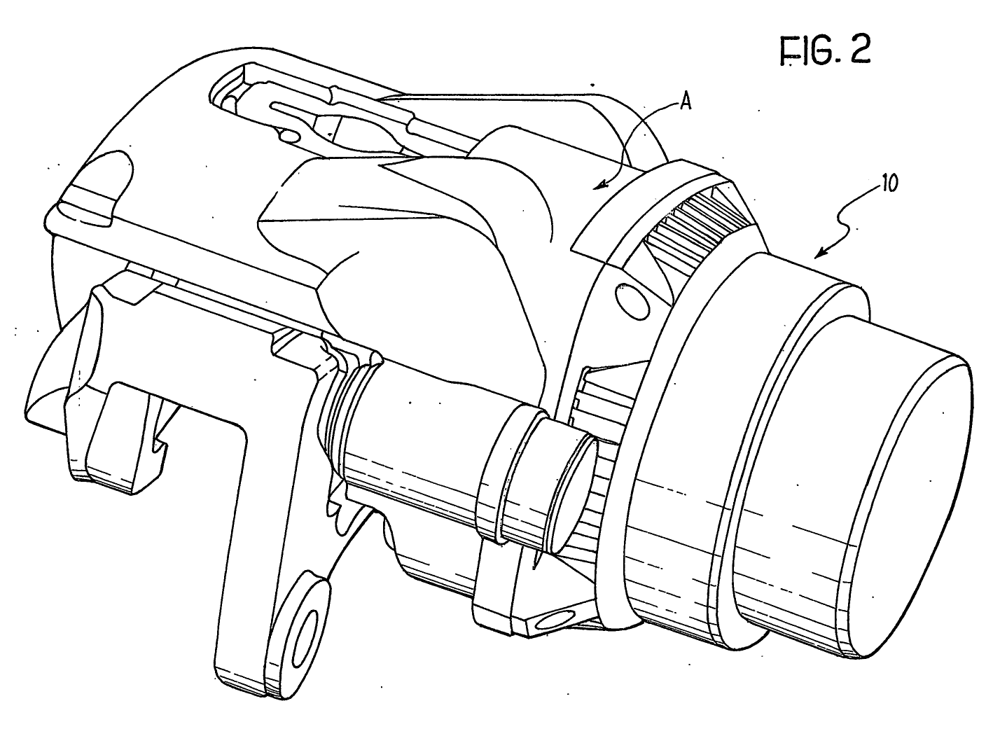

FIG. 2 is a perspective view showing the actuator assembly of FIG. 1 mounted onto the body of a brake caliper;

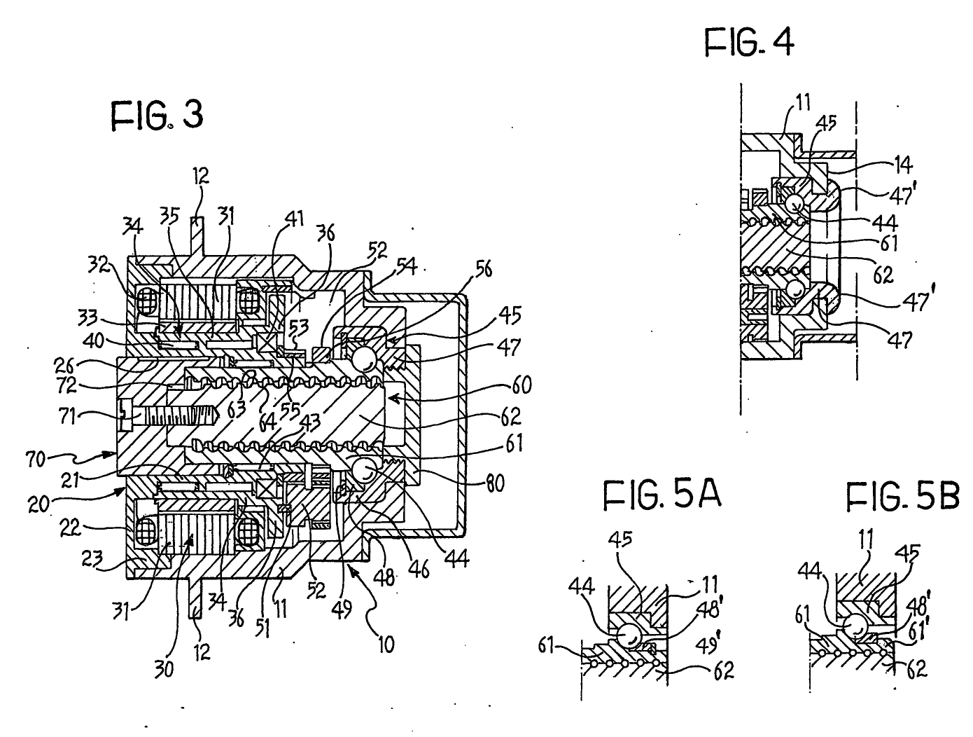

FIG. 3 is an axial longitudinal section of the assembly of FIG. 1;

FIGS. 4, 5A and 5B are partial axial sections of three possible variants, respectively;

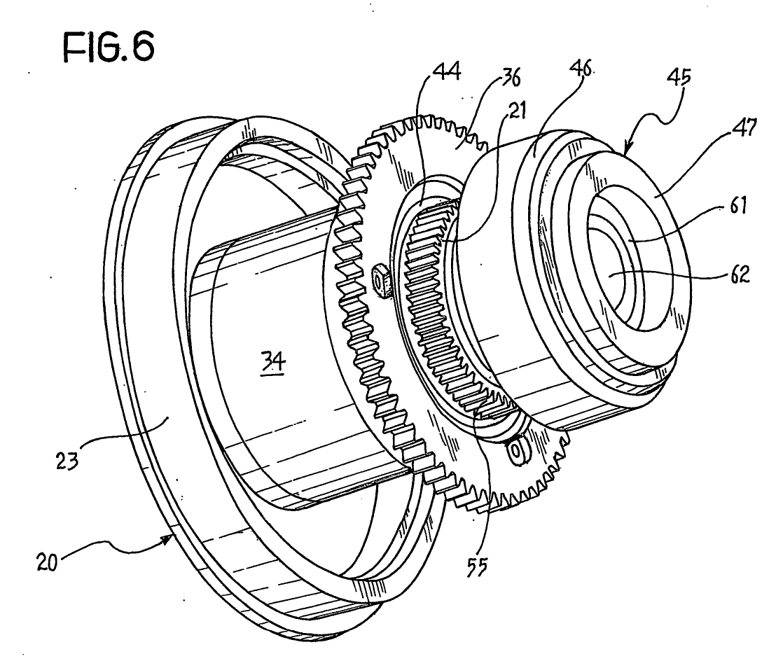

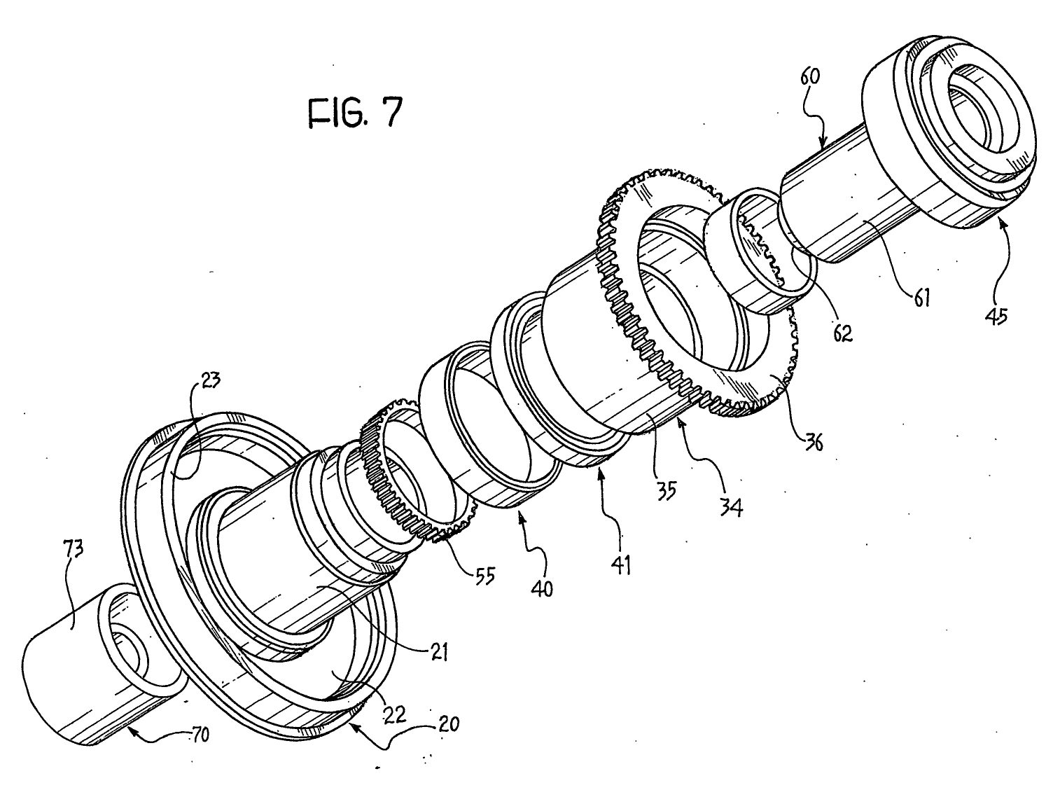

FIGS. 6 and 7 are a perspective view and an exploded perspective view, respectively, of a subassembly of the assembly of FIG. 1.

With reference initially to FIG. 1, an electro-mechanical assembly according to the invention is indicated overall 10. The assembly 10 comprises a housing 11 that forms outer radial flanges 12 with bores 13 for fastening the assembly to the body of a brake caliper A, schematically shown in FIG. 2. Naturally, reference to this possible field of application should not in any way be interpreted as limiting the scope of the patent.

An important characteristic of the solution according to the present invention is that the housing 11 is rigidly coupled or formed integral with a supporting body indicated overall 20 that forms a central tubular portion 21 extending inside the housing 11 coaxially to the central longitudinal axis x of the actuator assembly. As will be further explained hereinafter, the central tubular portion 21 supports internally and externally most of the rotating and translating transmission members of the actuator assembly, guaranteeing the correct alignment of their axes of rotation or translation and reducing to a minimum misalignments, eccentricities and the wear of these members.

At the output side of the actuator, the support body 20 forms a radial end wall 22, from which a tubular axial peripheral portion 23 extends for axially locking onto the housing 11 the stator 31 of an electric motor 30, preferably a brushless motor, incorporated in the actuator assembly. The stator windings are indicated 32. The peripheral portion 23 serves also for centering the housing 11 with respect to the central tubular portion 21.

The electric motor 30 comprises permanent magnets 33 fixed onto a tubular cylindrical portion 35 of a rotor 34 rotatably mounted onto the central tubular portion 21 of the supporting body 20 through a needle bearing 40 and a ball bearing 41.

Rotor 34 forms a radial flange 36 that serves as a planetary carrier for a planetary gear reduction system, indicated as a whole 50, through which the rotation of rotor 34 is transmitted to a nut member 61 of a screw mechanism 60, described herein after. Fixed onto the planet carrier flange 36 are axially protruding pins 51 on which there are mounted satellite gears 52 each having two toothed portions 53, 54 adjacent to one another. The toothed portions 53 and 54 mesh, respectively, with a fixed gear 55, secured to an outer cylindrical surface of the central tubular portion 21 of the supporting body 20, and an output gear 56 fixed onto the cylindrical outer surface of nut member 61.

In its essentially central part, the nut 61 is rotatably mounted within the central tubular portion 21 of supporting body 20 by means of a needle bearing 43. Towards the opposite end (to the right in FIGS. 1 and 3), the nut 61 is rotatably supported with respect to the housing 11 through an angular contact ball bearing 44, the radially inner raceway of which is formed directly by the nut 61. The radially outer raceway is formed by a sleeve member 45 with an inner most cylindrical tubular portion 46 of greater diameter and an outermost cylindrical tubular portion of smaller diameter 47. A separate annular member 48 contributes to form part of the radially outer raceway of the bearing 44 and is accommodated in the greater diameter portion 46 of the sleeve 47 and axially locked by means of a retainer ring 49 (seeger ring).

In the illustrated example, the screw mechanism 60 is a ballscrew. The nut 61 and the screw 62 have respective threads 63 and 64 formed correspondingly and accommodating balls (not shown) through which the rotary motion of the nut 61 is converted into a linear movement of translation of the central screw 62 along the longitudinal axis x of the actuator assembly. At the output end (to the left in FIGS. 1 and 3), the screw 62 is coupled non-rotatably with a piston member 70. The coupling between the piston member 70 and the screw 62 is provided by a fastening screw 71 and a splined coupling or a flat 72 formed (FIG. 3) at the interface between the piston 70 and the screw 62 to prevent relative rotation between these two members.

The piston member 70 has a cylindrical surface 73 accommodated with a slight radial play and axially guided within a cylindrical bore 24 of the central tubular portion 21 of the supporting body 20. Preferably, a splined or equivalent coupling 26 is provided at the interface between the bore 24 and the cylindrical surface 73 of the piston to prevent relative rotation between the piston and the stationary parts of the actuator. To this end, also a key coupling may be used.

A threaded locking member 80 is screwed in the outer portion 47 of the sleeve member 45 to axially lock onto the housing 11 the subassembly comprised of the sleeve member 45, the angular contact ball bearing 44 and the nut 61. In the variant shown in FIG. 4, instead of using a threaded locking element, the axial locking of said subassembly is accomplished by cold forming (preferably by rolling) an end portion 47′ of the sleeve member 45 that is deformed in a radially outer direction against a radial wall 14 of the housing 11.

In the variant embodiment of FIG. 5A, the radially outer raceway of the annular contact ball bearing 44 is formed completely by the sleeve member 45, whilst the radially inner raceway is formed partly by the nut 61 and partly by a separate annular member 48′ fixed axially to the nut through a seeger retaining member 49′.

The embodiment of FIG. 5B differs from that of FIG. 5A in that the separate ring 48′ is axially locked onto the nut 61 by cold forming (preferably by rolling) an end portion 61′ of the nut that is deformed in a radially outer direction against a radial wall of the ring 48′.

The embodiments of FIGS. 5A and 5B advantageously allow to further reduce the maximum outer diameter of the above mentioned subassembly.

When the electric motor 30 is activated, the rotor 34 drives the nut 61 for rotation through the planetary gear reduction system 50. The rotary motion of the nut is converted into a linear translation motion of the screw 62 through the recirculating balls (not shown), causing extension or withdrawal of the piston member 70, according to the direction of rotation imparted by the electric motor.

As compared to conventional solutions wherein transmission members similar or equivalent to those described above are cascade connected, the invention allows to keep under control and reduce to a minimum the eccentricity and misalignment between the transmission members of the actuator assembly, eliminating the drawback mentioned in the introductory part of the present description. This result is achieved owing to the central tubular portion 21 of the supporting body 20, which constitutes a single supporting element that determines an accurate reference for:

the axes of rotation of rotary members supported on the outside of the tubular portion 21, i.e. the rotor of the electric motor and the planetary gear reduction system;

the axis of rotation of the nut 61 supported on the inside of the central tubular portion 21; and

the axis of translation of the screw 62 and the piston 70, which is accommodated and axially guided precisely by the bore 24 of the tubular portion 21.

Furthermore, the peripheral portion 23 of the supporting body 20 allows a precise mounting of the stator 31 with respect to the rotor 34 of the electric motor.

It will be finally appreciated that the present invention allows to facilitate the assembling of the electric motor and the screw mechanism subassembly.

It is to be understood that the invention is not limited to the embodiments described and illustrated herein, which are to be considered as constructional examples of the actuator assembly. Further, the invention is likely to be modified as to shape and location of parts, constructional and functional details. For example, the various bearings on which the rotatable members are mounted may be of a different kind from those shown and may include plane, needle, ball, roller, bearings etc., as known to those skilled in the art.

1. An electro-mechanical screw actuator assembly, of the type comprising:
a housing (11) fixable to a motor vehicle,
an electric motor (30) mounted within the housing (11) and comprising a stator (31) fixed to the housing (11) and a rotor (34),
a screw mechanism (60), including a rotatable nut (61) and a central screw (62) translatable along a given axis (x),
gear reduction means (50) disposed between the rotor (34) and the screw mechanism (60) for provoking a translation of the screw (62),
wherein the housing (11) is secured to or integral with a supporting element (21) of essentially tubular cylindrical shape extending within the housing (11) coaxial to said axis (x), and wherein the supporting element (21)
externally, rotatably supports the rotor (34) of the electric motor (30), and
internally, rotatably supports the nut (61) of the screw mechanism (60);
wherein the supporting member (21) supports externally at least one fixed gear (55) of the gear reduction means (50).

2. The actuator assembly of claim 1, wherein the supporting member (21) forms an axial cavity (24) for accommodating and axially guiding a piston member (70) fixed to or integral with the screw (61) of the screw mechanism (60).

3. The actuator assembly of claim 1, wherein at the interface between the axial cavity (24) of the supporting member (21) and the piston member (70) there is provided an axial splined coupling or a form coupling (26) for preventing rotation of the screw (62) and/or the piston member (70) with respect to the housing (11).

4. The actuator assembly of claim 1, wherein the supporting member (21) is formed by a rigid body (20) having also a supporting means (23) for mounting the stator (31) of the electric motor (30).

5. The actuator assembly of claim 1, wherein the gear reduction means (50) include a planetary gear reduction system.

6. The actuator assembly of claim 5, wherein the rotor (34) forms a radial flange (36) that serves as a carrier for a plurality of satellite gears (52).

7. The actuator assembly of claim 6, wherein each of the satellite gears (52) has two toothed portions (53, 54), of which:
a first toothed portion (53) meshes with a fixed gear (55) fast with the tubular supporting member (21) and
a second toothed portion (54) meshes with a gear (56) fast for rotation with the nut (61).

8. The actuator assembly of claim 1, wherein the screw mechanism (60) is rotatably supported at an end thereof by an angular contact ball bearing (44).

9. The actuator assembly of claim 8, wherein the radially outer raceway of the angular contact ball bearing (44) is formed at least partially by a sleeve member (45) axially locked onto the housing (15).

10. The actuator assembly of claim 9, that wherein the sleeve member (45) is axially locked onto the housing (11) by cold forming an end portion (47′) of the sleeve member (45) deformed in a radially outer direction against a radial wall (14) of the housing (11).

11. The actuator assembly of claim 9, wherein the radially outer raceway of the angular contact for bearing (44) is formed entirely by a sleeve member (45), whilst the radially inner raceway is formed partly by the nut (61) and partly by a separate annular member (48′) axially locked (49′) onto the nut.

12. The actuator assembly of claim 11, wherein the separate annular member (48′) is axially locked onto the nut (61) by cold forming an end portion (61′) of the nut that is deformed in a radially outer direction against a radial wall of the separate ring (48′).

13. The actuator assembly of claim 1, wherein the screw mechanism (60) includes a ballscrew.

14. The actuator assembly of claim 1, wherein it is coupled with a brake caliper (A) for operating a braking force on a motor vehicle.

15. (canceled)
